(19) United States
(12) Patent Application Publication
(10) Pub. No.: US 2003/0196994 A1
(43) Pub. Date: Oct. 23, 2003

(54) Method, apparatus, and article of manufacture for determining an amount of energy needed to bring a quartz workpiece to a fusion weldable condition

(75) Inventors: Dmitri Nikitin, Daytona Beach Shores, FL (US); Thomas Micheal, Eustis, FL (US); Vladimire Borissovskii, Lake Mary, FL (US); Vladimir Nemera, Lake Mary, FL (US); Valeri Vlassov, Lake Mary, FL (US); Arnold Bykov, Lake Mary, FL (US)

Correspondence Address: FINNEGAN, HENDERSON, FARABOW, GARRETT & DUNNER, LLP, 1300 I STREET, NW, WASHINGTON, DC, 20005, US

(73) Assignee: Heraeus QuartzTech, Inc.

(21) Appl. No.: 10/420,839

(22) Filed: Apr. 23, 2003

Related U.S. Application Data
(63) Continuation of application No. 09/516,937, filed on Mar. 1, 2000, now abandoned.

(51) Int. Cl. B23K 26/32

(52) U.S. Cl. 219/121.64

(57) ABSTRACT

Methods, systems, and articles of manufacture consistent with the present invention determine an amount of energy required to bring a quartz workpiece to a fusion weldable condition. The fusion weldable condition is a state at which the quartz workpiece is in thermal balance while being substantially near but below a quartz sublimation point. Parameters of the quartz workpiece, such as thermal properties and dimensional data, are identified. Quantifiable parameters of a heat source (such as a laser's beam energy attributes and beam geometry) are also identified. Using these parameters, a relationship is generated representing a modeled state of thermal equilibrium for the weldable surface of the quartz workpiece. This relationship is used to determine the appropriate amount of energy to be applied to the quartz workpiece and associates a desired temperature of the workpiece with a transit time for applying the energy. Heat loss can be accounted for and adjusted as part of the determined amount of energy.

### BACKGROUND OF THE INVENTION

A. Field of the Invention

This invention relates to systems for quartz fusion welding and, more particularly, to systems for determining an amount of energy to apply to a quartz workpiece in order to heat the quartz workpiece to a thermal balance point where it becomes reflective just under a sublimation point and capable of being efficiently fusion welded to another workpiece.

B. Description of the Related Art

One of the most useful industrial glass materials is quartz glass. It is used in a variety of industries: optics, semiconductors, chemicals, communications, architecture, consumer products, computers and a plethora of associated and allied industries. In many of these industrial applications, it is important to be able to join two or more pieces together to make one large, uniform blank or finished part. For example, this may include joining two or more rods or tubes “end-to-end” in order to make a longer rod or tube. Additionally, this may involve joining two thick quartz blocks together to create one of the walls for a large chemical reactor vessel or a preform from which optical fiber can be made. These larger parts may then be cut, ground or drawn down to other usable sizes.

Many types of glasses have been “welded” or joined together with varying degrees of success. For many soft, low melting point types of glass, these attempts have been more successful than not. However, for the higher temperature compounds, such as quartz, welding has not been so easily accomplished. Even when welding of such higher temperature compounds is possible, the conventional processes are typically quite expensive and time consuming due to the manual nature of such a process and the required annealing times.

When attempting to weld quartz, there is a factor that is critical to the quartz welding process. This critical factor is the temperature of the weldable surface at the interface of the quartz workpiece to be welded. The temperature is critical because quartz itself does not actually go through what is conventionally considered to be classified as a liquid phase transition as does other materials, such as steel or water. Quartz sublimates, i.e., it goes from a solid state directly to a gaseous state. Those skilled in the art will appreciate that quartz sublimation is at least evident in the gross sense, on a macro level.

In order to achieve an optimal quartz weld, it is desirable to bring the quartz to a condition near sublimation but just under that point. There is a relatively narrow temperature zone in that condition, typically on the order of 1900 to 1970 degrees Celsius, within which one can optimally fusion weld quartz. In other words, in that usable temperature range, the quartz workpiece will fuse to another workpiece in that their molecules will become intermingled and become a single piece of water clear glass instead of two separate pieces with a joint. However, quartz vaporizes above that temperature range which essentially destroys part of the quartz workpiece at the weldable surface. Thus, one of the problems in achieving such an optimal quartz fusion weld is controlling how much energy is applied in order to bring the quartz workpiece up to such a weldable condition without vaporizing it.

Prior attempts to fusion weld quartz have used a hydrogen oxygen flame to apply energy to the weldable surface of the quartz workpiece. Unfortunately, most of the heat energy from the flame is undesirably lost, not uniformly applied, and causes a wind-tunnel effect that blows away sublimated quartz. Additionally, the flame is conventionally applied by hand where the welder repeatedly applies the heat and then attempts to test the plasticity of the quartz workpiece until ready for welding. This process remains problematic because it takes a very long time, wastes energy, usually introduces stresses within the weld requiring additional time for annealing and does not avoid sublimation of the quartz workpiece.

Another possibility for heating the quartz workpiece to a fusion weldable condition is to use a temperature feedback system. However, attempts to empirically take the temperature of the quartz workpiece as part of a feedback loop when welding have been found to be unreliable. Physical measurements of temperature undesirably load the quartz workpiece. Those skilled in the art will appreciate that this type of physical measurement also introduces uncertainties that are characteristic with most any physical measurement but especially present in the high temperature state of quartz when near or at a fusion weldable condition.

Accordingly, there is a need for a system for adequately determining an amount of energy required to bring a quartz workpiece to a fusion weldable condition without sublimating the quartz workpiece and doing so in a time efficient manner. Such a system will avoid applying too much energy (which vaporizes the quartz) or applying too little energy (which creates a cold joint requiring an undesirably long annealing process).

### SUMMARY OF THE INVENTION

Methods, systems, and articles of manufacture consistent with the present invention overcome these shortcomings by using a thermal balancing relationship to determine an amount of energy required to bring a quartz workpiece to a fusion weldable condition. This condition is essentially a state at which the quartz workpiece is at a thermal balance point and becomes optimally weldable. More particularly stated, the fusion weldable condition is considered to be substantially near but below a sublimation point of the quartz workpiece and where the quartz workpiece becomes reflective. Methods, systems, and articles of manufacture consistent with the present invention, as embodied and broadly described herein, identify parameters of the quartz workpiece related to a weldable surface of the quartz workpiece and identify heat source parameters associated with energy to be applied to the weldable surface. The workpiece parameters may include thermal properties of the workpiece and dimensional data describing the workpiece. The heat source parameters are typically quantifiable characteristics of a laser and may include beam energy attributes and beam geometry attributes.

Based upon these parameters, the amount of energy required to bring the quartz workpiece to the fusion weldable condition is determined, thus advantageously avoiding vaporization of the workpiece and enabling fusion welding of quartz in an automated fashion. In more detail, determining this amount of energy using these parameters may include modeling a state of thermal equilibrium for the quartz workpiece at the weldable surface. These parameters may then be used as part of the modeled state of thermal equilibrium in order to determine the amount of energy required to heat the quartz workpiece to a desired thermal balance condition.

The modeling step may also include generating a relationship representing the modeled state of thermal equilibrium. Such a relationship associates a desired temperature of the quartz workpiece and a transit time for a heat source applying energy to the quartz workpiece. According to the generated relationship and using a predetermined value for the desired temperature (preferably near but not above a sublimation temperature for the quartz workpiece), the amount of energy required may be determined. Typically, this may be accomplished by resolving a differential equation with boundary conditions in order to generate the relationship representing the state of thermal equilibrium. It is preferable to apply an integrating kernel, such as a Green's function, to resolve the differential equation with the boundary conditions and generate the relationship representing the state of thermal equilibrium.

Additionally, heat loss may be accounted for when determining the amount of energy required to bring the quartz workpiece to the desired thermal balance condition. This is normally accomplished by adjusting the determined amount of energy to compensate for losing a portion of the energy to be applied to the weldable surface of the workpiece.

### BRIEF DESCRIPTION OF THE DRAWINGS

The accompanying drawings, which are incorporated in and constitute a part of this specification, illustrate an implementation of the invention. The drawings and the description below serve to explain the advantages and principles of the invention. In the drawings,

FIG. 1 is a block diagram of an exemplary quartz fusion welding system with which the invention may be implemented;

FIG. 2 is a diagram illustrating a quartz plate as an exemplary quartz workpiece; and

FIG. 3 is a flow chart illustrating typical steps performed by the exemplary quartz fusion welding system consistent with an exemplary embodiment of the present invention.

### DETAILED DESCRIPTION

Reference will now be made in detail to an implementation consistent with the present invention as illustrated in the accompanying drawings. Wherever possible, the same reference numbers will be used throughout the drawings and the following description to refer to the same or like parts.

Introduction

In general, methods and systems consistent with the present invention determine an appropriate amount of energy to be applied to a quartz workpiece in order to bring the workpiece to a fusion weldable condition. In order to successfully weld quartz, a careful balance of thermal load at the weldable surface should be maintained in order to create the boundary conditions for the quartz to properly intermingle or fuse on a molecular level and avoid the creation of a cold joint that is improperly fused. Those skilled in the art will appreciate that use of the terms “quartz”, “quartz glass”, “vitreous quartz”, “vitrified quartz”, “vitreous silica”, and “vitrified silica” are interchangeable regarding embodiments of the present invention.

In more detail, when quartz transitions from its solid or “super-cooled liquid” state to the gaseous state it evaporates or vaporizes. The temperature range between the liquid and gaseous state is somewhere around 1900 degrees Celsius (C.) and 1970 degrees C. This temperature varies slightly because of trace elements in the material and environmental conditions. When heated from its solid or super-cooled state to a super-cooled but very hot, more mobile state, the quartz becomes tacky or super-plastic. Applicants have found that it does not cold flow much faster than at lower elevated temperatures and it does not flow (in the sense of sagging) particularly fast but it does become very sticky.

As the temperature approaches this range, the thermal properties of quartz change radically. Below 1900 degrees C., a thermal conductivity curve for quartz is fairly flat and linear (positive). However, at temperatures greater than approximately 1900 degrees C. and below the sublimation point, thermal conductivity starts to increase as a third order function. As the quartz reaches a desired temperature associated with the fusion weldable, applicants have discovered that it becomes a thermal mirror or a very reflective surface.

The quartz thermal conductivity non-linearly increases with thermal input and increasing temperature. There exists a set of variable boundary layer conditions that thermal input influences. This influence changes the depth of the boundary layer. This depth change results in or causes a dramatic shift in the thermal characteristics (coefficients) of various thermal parameters. The cumulative effect of the radical thermal conductivity change is the cause of the quartz material's abrupt change of state. When its heat capacity is saturated, all of the thermal parameters become non-linear at once causing abrupt vaporization of the material.

This boundary layer phenomenon is further examined and discussed below. The subsurface layers of the quartz workpiece has, to some depth, a coefficient of absorption which is fixed at “Initial Conditions” (IC) described below in Table 1.

TABLE I

| | |
|---|---|
| Let the coefficient of thermal absorption of laser | k |
| radiation be: | |
| Let the depth of the sub-surface layer be: | d |
| Let the coefficient of heat capacity be: | c |
| Let the coefficient of reflectance be: | r |
| Let the coefficient of thermal conduction be: | λ |
| Let the density be: | ρ |

As the quartz is heated over a temperature range below 1900 degrees C., k increases but with a shallow slope and d remains relatively constant and fairly large. However, applicants have found that as the temperature exceeds 1900 degrees C., the slope of k increases at a third-order (cubic) rate until it becomes asymptotic with an increase in thermal conductivity. Simultaneously, the depth of sub-surface penetration d decreases similarly. This causes an increase in the thermal gradient within the quartz workpiece that reduces the bulk thermal conductivity but increases it at the thinning boundary layer on the weldable surface.

As a result, the heat energy is concentrated in the boundary layer at the weldable surface. As this concentration occurs, the coefficient of thermal conductivity increases. These dramatic, non-linear, boundary layer phenomena thermal property changes create a condition where the energy causes the (finite) weldable surface of the quartz workpiece to become quasi-fluid. As explained above, this condition is at the ragged edge of sublimation. A few more calories of heat and the quartz vaporizes. It is within this temperature range and viscosity region that effective quartz fusion welding can occur. The difficulty in attaining these two conditions simultaneously is that (1) in general, heating is a random, generalized process, and (2) heating is not a precisely controllable parameter. Embodiments of the present invention focus on determining the appropriate amount of energy to bring a given quartz workpiece within this temperature range and viscosity region under multiple variant conditions of the welding geometry.

For optimal fusion welding, it is important to determine how much heat is needed to raise the quartz workpiece's temperature to just under the vaporization or sublimation point. At the same time, the gradient must be controlled so as to prevent thermal stresses that will cause long term or short term fracture failure. In embodiments of the present invention, this is accomplished by effectively modeling a thermal balance of the quartz material in order to determine the amount of energy (energy from a laser, or other heat source) that is required to heat a quartz workpiece to its thermal balance point (thermal-equilibrium). For purposes of this application, the term “quartz workpiece” may include one or more pieces of quartz stock that are to be welded together to form a single object.

System Architecture

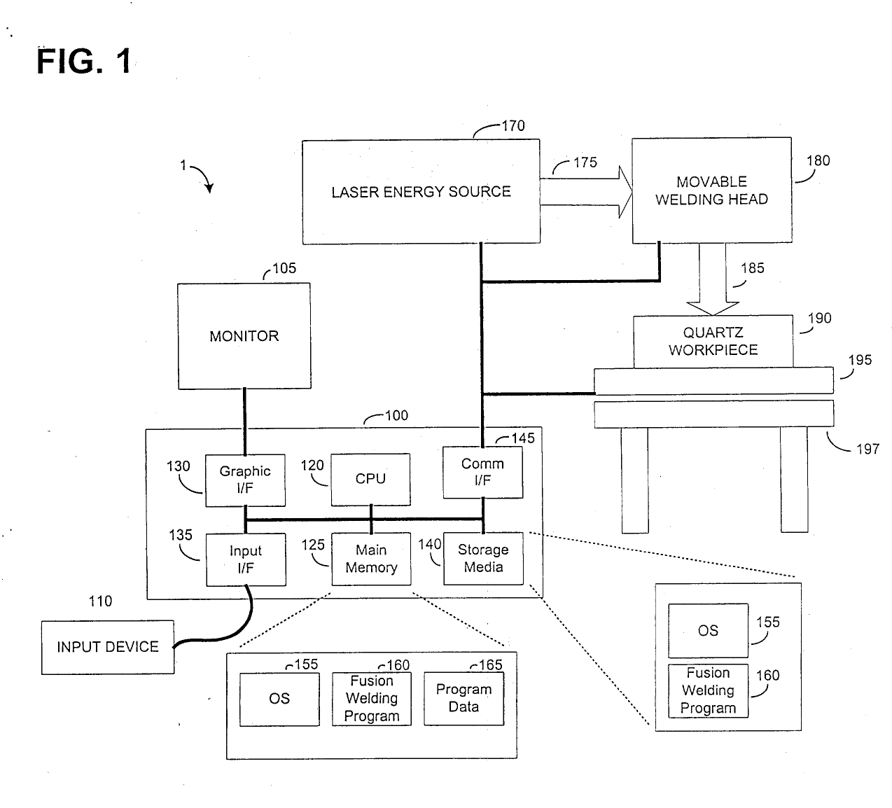

In order to provide an operating environment for an embodiment of the present invention, an exemplary quartz fusion welding system is illustrated in FIG. 1 that is suitable for practicing methods and implementing systems consistent with the present invention. Referring now to FIG. 1, the exemplary quartz fusion welding system 1 includes a laser energy source 170, a movable welding head 180, a working table 197 having a movable working surface 195, and a computer system 100. Laser energy source 170 provides energy in the form of a laser beam 175 to movable welding head 180. Movable welding head 180 receives laser beam 175 and directs its energy in a beam 185 upon a weldable surface of quartz workpiece 190 in accordance with instructions from computer system 100. In this manner, a laser is used apply energy to for fusion welding of the quartz workpiece.

Computer system 100 sets up and controls laser energy source 170, movable welding head 180, and movable working surface 195 in a precise and coordinated manner during fusion welding of the quartz workpiece 190. Computer system 100 turns on laser energy source 170 for discrete periods of time. Computer system 100 also controls the relative positioning of movable welding head 180 and movable working surface 195 relative to the workpiece 190 so that surfaces on the workpiece 190 can be easily fusion welded in an automated fashion. While not shown in detail, movable working surface 195 typically includes components allowing it to move along a longitudinal axis as well as rotate relative to the movable welding head 180.

Looking at computer system 100 in more detail, it contains a processor (CPU) 120, main memory 125, computer-readable storage media 140, a graphics interface (Graphic I/F) 130, an input interface (Input I/F) 135 and a communications interface (Comm I/F) 145, each of which are electronically coupled to the other parts of computer system 100. In the exemplary embodiment, computer system 100 is implemented using an Intel PENTIUM III® microprocessor (as CPU 120) with 128 Mbytes of RAM (as main memory 125).

Graphics interface 130, preferably implemented using a graphics interface card from 3Dfx, Inc. headquartered in Richardson, Tex., is connected to monitor 105 for displaying information (such as prompt messages) to a user. Input interface 135 is connected to an input device 110 and can be used to receive data from a user. In the exemplary embodiment, input device 110 is a keyboard and mouse but those skilled in the art will appreciate that other types of input devices (such as a trackball, pointer, tablet, touchscreen or any other kind of device capable of entering data into computer system 100) can be used with embodiments of the present invention.

Communications interface 145 electronically couples computer system 100 (including processor 120) to other parts of the quartz fusion welding system 1 to facilitate communication with and control over those other parts. In the exemplary embodiment of the present invention, communication interface 145 includes an Ethernet network interface and an RS-232 interface for connecting to hardware that implement control systems within movable welding head 180 and movable working surface 195. In the exemplary embodiment, such hardware is implemented with Parker 6K4 Controllers (not shown) associated with stepper motors (not shown) and other actuators (not shown). Those skilled in the art will recognize other ways in which to connect computer system 100 with other parts of fusion welding system 1, such as through conventional IEEE-488 or GPIB instrumentation connections. In the exemplary embodiment, communication interface 145 also includes a direct electrical connection to laser energy source 170 used to setup and control laser energy source 170.

Once computer system 100 is booted up, main memory 125 contains an operating system 155, one or more application program modules (such as fusion welding program 160), and program data 165. In the exemplary embodiment, operating system 155 is the WINDOWS NT™ operating system created and distributed by Microsoft Corporation of Redmond, Wash. While the WINDOWS NT™ operating system is used in the exemplary embodiment, those skilled in the art will recognize that the present invention is not limited to that operating system. For additional information on the WINDOWS NT™ operating system, there are numerous references on the subject that are readily available from Microsoft Corporation and from other publishers.

Computer-readable storage media 140 is preferably implemented as a hard disk drive that maintains files, such as operating system 155 and fusion welding program 160, in secondary storage separate from main memory 125. One skilled in the art will appreciate that all or part of systems and methods consistent with the present invention may be stored on or read from other computer-readable media, such as secondary storage devices (e.g., floppy disks, optical disks, and CD-ROM); a carrier wave received from a data network (such as the global Internet); or other forms of ROM or RAM.

Fusion Welding Process

In the context of the above described system, fusion welding program 160 controls setting up parts of quartz fusion welding system 1 and applies a specific amount of energy to the workpiece in a very precise and controlled manner. The energy is advantageously and uniformly applied to the workpiece so that vaporization of the workpiece is advantageously avoided. In the exemplary embodiment of the present invention, fusion welding program 160 is implemented as an object-oriented software module written in Microsoft Visual Basic 6.0 with the assistance of Microsoft Visual Studio 6.0. ActiveX controls as defined by Microsoft are preferably used for communication and data transfer to and from other software modules, such as operating system 155.

As part of setting up to perform a welding operation, fusion welding program 160 determines how much energy is needed to bring the quartz workpiece to the desired fusion weldable condition without vaporizing it prior to causing that amount of energy to be applied. Focusing on this critical part of the welding process, parameters related specifically to the quartz workpiece along with heat source parameters are provided to computer system 100 as program data 165. These parameters are identified, accessed and received by fusion welding program 160 for use in the determination of the appropriate amount of energy.

The parameters related to the quartz workpiece typically include thermal properties of the quartz workpiece and dimensional data associated with the quartz workpiece. In the exemplary embodiment of the present invention, these thermal properties include the coefficient of thermal conduction, the coefficient of absorption of laser radiation, the specific heat of the quartz workpiece, the density of the quartz workpiece and the desired temperature to which to bring the quartz workpiece. The desired temperature is normally a temperature substantially near but below the sublimation point for quartz. In the exemplary embodiment, the desired temperature is approximately 1940 degrees C.

Additionally, in the exemplary embodiment, the quartz workpiece is soaked at an initial preheating temperature to help avoid rapid changes in temperature that may induce stress cracks within the weld. In the exemplary embodiment, the preheating temperature is typically between 500 and 700 degrees C. and is preferably applied with a laser. Other embodiments may include no preheating or may involve applying energy for such preheating using other heat sources, such as a hydrogen-oxygen flame.

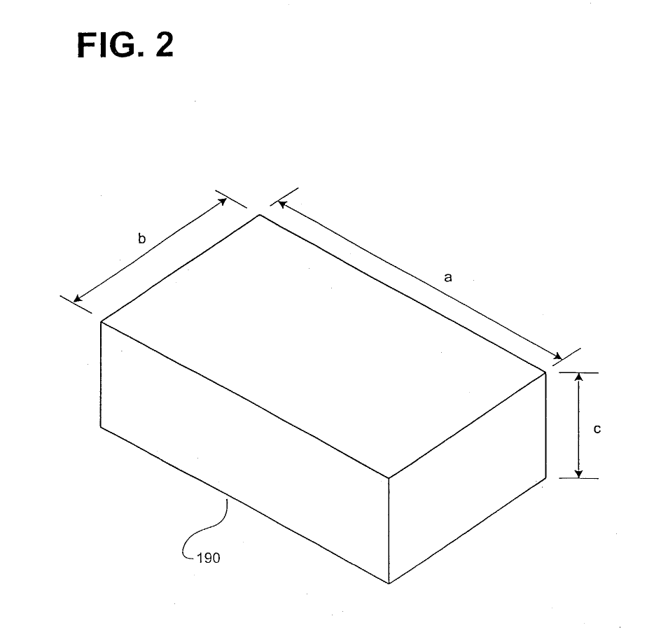

In an example, a quartz plate (such as quartz workpiece 190 illustrated in FIG. 2) may be used as the workpiece having a coefficient of thermal conduction of 2.0 (watts/meter×degree K.), a coefficient of absorption of approximately 20 mm⁻¹, a specific heat of 10³ J/Kg° K., a density of 2.21×10³ kg/m³ and a desired temperature of 1940 degrees C. Each of these properties is entered into the computer 100 and used by fusion welding program 160.

The dimensional data essentially describes the size, physical attributes and orientation of the quartz workpiece. In the exemplary embodiment, the dimensional data typically includes a description of the x, y, and z-axes dimensions of the quartz workpiece and weldable surface as well as any rotational information required to describe the weldable surface on the quartz workpiece. For example, the weldable surface on the quartz workpiece may be a flat surface on the edge of a quartz workpiece that is easily described in terms of rectangular coordinates. However, the weldable surface may be an angular edge on the workpiece requiring the use of rotational information in degrees regarding the location for the fusion weld. In the quartz plate example illustrated in FIG. 2, dimensional data includes length “a” of 25 mm, width “b” of 50 mm, and height “c” of 10 mm, each of which are used to characterize the size, edges and surfaces of quartz workpiece 190.

Dimensional data may also include measurements of a gap between the quartz workpiece and the piece to which it is to be welded and the type of weld desired. The type of weld desired is used to help determine how energy will be applied to the quartz workpiece. For example, the type of weld may be an “end-to-end” weld or a “circle” weld. An end-to-end weld is a weld starting from a beginning point and ending at a different point on the quartz workpiece. A circle weld is a weld that starts from a beginning point and is ended at the same point. A circle weld also has dimensional data such as radius and rotational information that characterize the locations to be welded.

The open or closed nature of the weld is also information that may be considered as dimensional data taken into account when determining the appropriate amount of energy to apply to the quartz workpiece. If the weld is considered an open weld, then no special adjustments need be made. However, if the weld is considered to be closed (such as when there is a circle weld), it is desirable to decrease the amount of energy applied at the very end of the welding process. This can be important because as the heat source energy is moved relative to the quartz workpiece back to the beginning point in order to complete the circle weld, there is appreciable latent energy at the beginning point. Thus, the amount of additional energy needed to heat the quartz material at the beginning point to the desired condition is reduced. Applying too much energy (given the latent energy at this point) undesirably causes “punch out” or vaporization of the quartz workpiece. Thus, an estimated or calculated reduction in energy required when closing a “closed” weld can be advantageously determined.

In the exemplary embodiment, dimensional data also includes information related to estimated or interpolated dimensions associated with the weldable surface of the workpiece. Fusion welding can be used to join two workpieces that have broken apart. The edges may not be simply measured or accurately described without some error. Thus, the weldable surface may have dimensions that require some type of interpolation. In this context, dimensional data may also include a description of how such dimensional information has been interpreted such as using conventional three-point interpolation or multipoint interpolation techniques. Those skilled in the art will appreciate that there are many techniques of interpolating such dimensions that are easily applicable to the principles described above. In this manner, an interpolation can be used to describe an unusually shaped edge or surface on the workpiece.

The heat source parameters are quantifiable characteristics of the energy to be applied to the quartz workpiece, such as parameters associated with laser energy source 170. These parameters include characteristics generally referred to as beam energy attributes and beam geometry attributes. Essentially, beam energy attributes quantifiably describe the energy in laser beam 185 as it is applied to quartz workpiece 190. In the exemplary embodiment, such beam energy attributes include a power level in laser beam 185, a duration or duty cycle of laser beam 185, and a description of how energy is distributed within laser beam 185. For example, for a particular welding process, the laser beam 185 may be set for 150 Watts of power at a 20 percent duty cycle that distributes the energy within the beam in a Gaussian profile.

Additionally, beam geometry attributes quantifiably describe where the energy from the laser beam is being applied. For example, beam geometry attributes include one or more focal characteristics and one or more spot dimensions of the laser beam. In the exemplary embodiment, these beam geometry attributes include the focal length of laser beam 185, spot size, and spot geometry for a beam. In the exemplary embodiment, laser energy source 170 is one or more sealed CO₂ lasers having a predefined wavelength of 10.6 microns. The laser is typically capable of providing up to 360 Watts of laser power, has a focal length of 3.75 inches and a focal spot size of 0.2 mm in diameter. While it is preferred to use one or more lasers as the energy source, it is contemplated that other sources of energy may also work when the applicable energy from that source is quantifiable in amount and distribution.

In the exemplary embodiment, the beam energy attributes and beam geometry attributes are either manually set or fixed characteristics of the heat source. However, principles of the present invention contemplate implementing automatic systems capable of remotely controlling all functions of the heat source and movable elements used to apply the energy (e.g., movable welding head 180 and movable surface 195).

As previously stated, these parameters (workpiece parameters and heat source parameters) are identified, accessed and received by fusion welding program 160 for use in the determination of the amount of energy needed to bring the workpiece to a fusion weldable state. In order to make such a determination, fusion welding program 160 cleverly generates a relationship representing a modeled state of thermal equilibrium at the weldable surface of the quartz workpiece. Essentially, this mathematically represented thermodynamic relationship models the thermal balance of the quartz workpiece and associates a temperature of the quartz workpiece at the weldable surface with a transit time for applying the energy to a point on the weldable surface. Basically, the thermal equilibrium relationship is generated using a differential equation with boundary conditions and applying a Green's function to resolve a solution to the equation. Thus, based upon the provided parameters applied to such a solution, the relationship can be used to yield an amount of energy needed to bring the quartz workpiece to a desired temperature near but below a sublimation point. This amount of energy is typically in the form of a value of transit time in which to apply energy from the beam to the workpiece. In the exemplary embodiment, movable welding head 180 in conjunction with movable working surface 195 are able to provide transit velocities of up to 30 mm/minute when laser fusion welding.

A detailed explanation appears below regarding how this relationship can be generated. In accordance with an exemplary embodiment of the present invention, those skilled in the art will appreciate that the following differential equation, specifically an inhomogeneous diffusion equation in three dimensions, is to be resolved in a half-infinite space defined by z=0 to z=∞:

$$c ρ \frac{\partial }{\partial t} T - λ {\vec{∇}}^{2} T = kI ( r , t ) {ⅇ}^{- kz} \qquad ( 1 )$$

where T=temperature; c=specific heat; ρ=density; λ=coefficient of thermal conduction; and k=coefficient of absorption of laser radiation.

The following are boundary conditions:

T(r,z,t=0)=T₀ (2)

$$\frac{\partial }{\partial z} T ( r , z = 0 , t ) = 0 \qquad ( 3 )$$

As a first step, a substitution of variables occurs as follows:

$$\begin{matrix}α = \frac{λ}{c ρ} & ( 4 ) \\ κ = \frac{kI}{c ρ} & ( 5 )\end{matrix}$$

so that EQ. (1) can be rewritten:

$$\frac{\partial }{\partial t} T - α {\vec{∇}}^{2} T = κ {ⅇ}^{- kz} \qquad ( 6 )$$

In order to solve EQ. (6), it is possible to first solve the homogenous version, and then to determine the appropriate Green's function to apply. The homogeneous version of EQ. (6) is:

$$\frac{\partial }{\partial t} ξ - α {\vec{∇}}^{2} ξ = 0 \qquad ( 7 )$$

where ξ denotes the corresponding homogeneous version of the temperature T. A Green's function solution to EQ. (7) is as follows:

$$ξ = \frac{1}{{8 [ π α ( t - τ ) ]}^{\frac{3}{2}}} {ⅇ}^{- [ {( x - {x}^{′} )}^{2} + {( y - {y}^{′} )}^{2} + {( z - {z}^{′} )}^{2} ] / 4 α ( t - τ )} \qquad ( 8 )$$

The solution presented in EQ. (8) is recast to reflect the cylindrical symmetry of the thermal equilibrium problem as well as to apply the appropriate boundary conditions.

As part of this recasting, the following definite integral can be used:

$${\int }_{- ∞}^{∞} {ⅇ}^{- ( {ax}^{2} + bx + c )} ⅆ x = \sqrt{\frac{π}{a}} {ⅇ}^{( {b}^{2} - 4 ac ) / 4 a} \qquad ( 9 )$$

as well as the following definite integral:

$${\int }_{0}^{∞} {ⅇ}^{- ax} {J}_{0} ( b \sqrt{x} ) ⅆ x = \frac{{ⅇ}^{- {b}^{2} / 4 a}}{a} \qquad ( 10 )$$

where J₀ denotes a Bessel function of the-first kind of order n=0. Thus, without any loss of generality, EQ. (8) is rewritten using EQS. (9) and (10) as:

$$ξ = \frac{1}{4 {π}^{2}} {\int }_{η = 0}^{η = ∞} {\int }_{γ = - ∞}^{γ = ∞} ψ ( η , γ ) {ⅇ}^{- [ α ( t - τ ) ( {η}^{2} + {γ}^{2} ) + i ( z - {z}^{′} ) γ ]} {J}_{0} ( \vert r - {r}^{′} \vert η ) η ⅆ η ⅆ γ \qquad ( 11 )$$

where |r|=\sqrt{x²+y²}, |r′|=\sqrt{x′²+y′²}, |r−r′|=\sqrt{(x−x′)²+(y−y′)²}, i=\sqrt{−1}, η and γ are arbitrary integration variables and ψ(η,γ) is an arbitrary function of η and γ which will allow one to impose the boundary conditions of EQS. (2) and (3). Thus, if the condition, in analogy with EQ. (2), is imposed:

ξ(r,r′,z,z′,t=τ)=ξ₀(r,r′,z,z′) (12)

then:

$${ξ}_{0} ( r , {r}^{′} , z , {z}^{′} ) = \frac{1}{4 {π}^{2}} {\int }_{η = 0}^{η = ∞} {\int }_{γ = - ∞}^{γ = ∞} ψ ( η , γ ) {ⅇ}^{- ⅈ ( z - {z}^{′} ) γ} {J}_{0} ( \vert r - {r}^{′} \vert η ) η ⅆ η ⅆ γ \qquad ( 13 )$$

The conventional definition of a Dirac delta function can then be used:

$$δ ( x ) = \frac{1}{2 π} {\int }_{y = - ∞}^{y = ∞} {ⅇ}^{ⅈ x y} ⅆ y \qquad ( 14 )$$

to obtain the relationship:

$$\begin{matrix}{\int }_{{z}^{′} = - ∞}^{{z}^{′} = ∞} {ξ}_{0} ( r , {r}^{′} , z , {z}^{′} ) {ⅇ}^{ⅈ ( z - {z}^{′} ) {γ}^{′}} ⅆ {z}^{′} = \\ \frac{1}{4 {π}^{2}} {\int }_{{z}^{′} = - ∞}^{{z}^{′} = ∞} {\int }_{η = 0}^{η = ∞} {\int }_{γ = - ∞}^{γ = ∞} ψ ( η , γ ) {ⅇ}^{- ⅈ ( z - {z}^{′} ) ( γ - {γ}^{′} )} {J}_{0} ( \vert r - {r}^{′} \vert η ) η ⅆ η ⅆ γ ⅆ {z}^{′} & ( 15 ) \\ or : {\int }_{{z}^{′} = - ∞}^{{z}^{′} = ∞} {ξ}_{0} ( r , {r}^{′} , z , {z}^{′} ) {ⅇ}^{ⅈ ( z - {z}^{′} ) {γ}^{′}} ⅆ {z}^{′} = \\ \frac{1}{2 π} {\int }_{η = 0}^{η = ∞} {\int }_{γ = - ∞}^{γ = ∞} ψ ( η , γ ) δ ( γ - {γ}^{′} ) {ⅇ}^{- ⅈ z ( γ - {γ}^{′} )} {J}_{0} ( \vert r - {r}^{′} \vert η ) η ⅆ η ⅆ γ & ( 16 )\end{matrix}$$

so that, performing the integration over γ.

$${\int }_{{z}^{′} = - ∞}^{{z}^{′} = ∞} {ξ}_{0} ( r , {r}^{′} , z , {z}^{′} ) {ⅇ}^{ⅈ ( z - {z}^{′} ) {γ}^{′}} ⅆ {z}^{′} = \frac{1}{2 π} {\int }_{η = 0}^{η = ∞} ψ ( η , {γ}^{′} ) {J}_{0} ( \vert r - {r}^{′} \vert η ) η ⅆ η \qquad ( 17 )$$

Next, the following identity for the Dirac delta function is used:

$$δ ( x - {x}^{′} ) = x {\int }_{y = 0}^{y = ∞} {J}_{n} ( y x ) {J}_{n} ( y {x}^{′} ) y ⅆ y \qquad ( 18 )$$

where the Jₙ( ) are Bessel functions of the first kind of order n. We can also use the “summation theorem” for Bessel functions:

$${J}_{0} ( \vert r - {r}^{′} \vert η ) = {J}_{0} ( r η ) {J}_{0} ( {r }^{′} η ) + 2 {\sum }_{k = 1}^{k = ∞} {J}_{k} ( r η ) {J}_{k} ( {r }^{′} η ) cos ( k ϕ ) \qquad ( 19 )$$

where

|r−r′|=\sqrt{r²+r′²−2rr′ cos (Φ)} (20)

Therefore, EQ. (17) can be rewritten as:

$$\begin{matrix}{\int }_{{z}^{′} = - ∞}^{{z}^{′} = ∞} {ξ}_{0} ( r , {r}^{′} , z , {z}^{′} ) {ⅇ}^{ⅈ ( z - {z}^{′} ) {γ}^{′}} ⅆ {z}^{′} = \frac{1}{2 π} {\int }_{η = 0}^{η = ∞} ψ ( η , {γ}^{′} ) {J}_{0} ( r η ) {J}_{0} ( {r }^{′} η ) η ⅆ η + \\ \frac{1}{π} {\sum }_{k = 1}^{k = ∞} {\int }_{η = 0}^{η = ∞} ψ ( η , {γ}^{′} ) {J}_{k} ( r η ) {J}_{k} ( {r }^{′} η ) cos ( k ϕ ) η ⅆ η\end{matrix} \qquad ( 21 )$$

Because of the cylindrical symmetry of the problem, each side is integrated over r′dΦ, where Φ takes on the values from 0 to 27π, and we obtain:

$$2 π {\int }_{{z}^{′} = - ∞}^{{z}^{′} = ∞} {ξ}_{0} ( r , {r}^{′} , z , {z}^{′} ) {ⅇ}^{ⅈ ( z - {z}^{′} ) {γ}^{′}} {r}^{′} ⅆ {z}^{′} = {\int }_{η = 0}^{η = ∞} ψ ( η , {γ}^{′} ) {J}_{0} ( r η ) {J}_{0} ( {r }^{′} η ) {r }^{′} η ⅆ η \qquad ( 22 )$$

Each side can be multiplied by J₀(r′, η′), and integrated over dr′ from r′=0 to r′=∞ to obtain:

$$\begin{matrix}2 π {\int }_{{r}^{′} = 0}^{{r}^{′} = ∞} {\int }_{{z}^{′} = - ∞}^{{z}^{′} = ∞} {ξ}_{0} ( r , {r}^{′} , z , {z}^{′} ) {J}_{0} ( {r }^{′} {η}^{′} ) {ⅇ}^{ⅈ ( z - {z}^{′} ) {γ}^{′}} {r }^{′} ⅆ {r }^{′} ⅆ {z }^{′} = \\ {\int }_{{r}^{′} = 0}^{{r}^{′} = ∞} {\int }_{η = 0}^{η = ∞} ψ ( η , {γ}^{′} ) {J}_{0} ( r η ) {J}_{0} ( {r }^{′} η ) {J}_{0} ( {r }^{′} {η}^{′} ) {r }^{′} ⅆ {r }^{′} η ⅆ η\end{matrix} \qquad ( 23 )$$

Thus, from EQ. (18), we obtain:

$$\begin{matrix}2 π {\int }_{{r}^{′} = 0}^{{r}^{′} = ∞} {\int }_{{z}^{′} = - ∞}^{{z}^{′} = ∞} {ξ}_{0} ( r , {r}^{′} , z , {z}^{′} ) {J}_{0} ( {r }^{′} {η}^{′} ) {ⅇ}^{ⅈ ( z - {z}^{′} ) {γ}^{′}} {r }^{′} ⅆ {r }^{′} ⅆ {z }^{′} = \\ {\int }_{η = 0}^{η = ∞} ψ ( η , {γ}^{′} ) {J}_{0} ( r η ) δ ( η - {η}^{′} ) ⅆ η\end{matrix} \qquad ( 24 )$$

and after integrating over η, we obtain:

$$\begin{matrix}2 π {\int }_{{r}^{′} = 0}^{{r}^{′} = ∞} {\int }_{{z}^{′} = - ∞}^{{z}^{′} = ∞} {ξ}_{0} ( r , {r}^{′} , z , {z}^{′} ) {J}_{0} ( {r }^{′} {η}^{′} ) {ⅇ}^{ⅈ ( z - {z}^{′} ) {γ}^{′}} {r }^{′} ⅆ {r }^{′} ⅆ {z }^{′} = \\ ψ ( {η}^{′} , {γ}^{′} ) {J}_{0} ( r {η}^{′} )\end{matrix} \qquad ( 25 )$$

Before proceeding, EQ. (11) is recast in order to reflect the cylindrical symmetry of our problem. Thus, the “summation theorem” of EQ. (19) is again used in order to rewrite EQ. (11) as:

$$ξ = \frac{1}{4 {π}^{2}} {\int }_{η = 0}^{η = ∞} {\int }_{γ = - ∞}^{γ = ∞} ψ ( η , γ ) {ⅇ}^{- [ α ( t - τ ) ( {η}^{2} + {γ}^{2} ) + i ( z - {z}^{′} ) γ ]} {J}_{0} ( r η ) {J}_{0} ( {r}^{′} η ) η ⅆ η ⅆ γ + \\ + \frac{1}{2 {π}^{2}} {\sum }_{k = 1}^{k = ∞} {\int }_{η = 0}^{η = ∞} {\int }_{γ = - ∞}^{γ = ∞} ψ ( η , γ ) {ⅇ}^{- [ α ( t - τ ) ( {η}^{2} + {γ}^{2} ) + i ( z - {z}^{′} ) γ ]} {J}_{k} ( r η ) {J}_{k} ( {r}^{′} η ) cos ( k ϕ ) η ⅆ η ⅆ γ \qquad ( 26 )$$

Again, because of the cylindrical symmetry, each side of EQ. (26) is integrated over dΦ from Φ=0 to Φ=2π to obtain:

$$ξ = \frac{1}{4 {π}^{2}} {\int }_{η = 0}^{η = ∞} {\int }_{γ = - ∞}^{γ = ∞} ψ ( η , γ ) {ⅇ}^{- [ α ( t - τ ) ( {η}^{2} + {γ}^{2} ) + i ( z - {z}^{′} ) γ ]} {J}_{0} ( r η ) {J}_{0} ( {r}^{′} η ) η ⅆ η ⅆ γ \qquad ( 27 )$$

Therefore, using the results derived above in EQ. (25), namely:

$$ψ ( η , γ ) {J}_{0} ( r η ) = 2 π {\int }_{{r}^{″} = 0}^{{r}^{″} = ∞} {\int }_{{z}^{″} = - ∞}^{{z}^{″} = ∞} {ξ}_{0} ( r , {r}^{″} , z , {z}^{″} ) {J}_{0} ( {r}^{″} η ) {ⅇ}^{ⅈ ( z - {z}^{″} ) γ} {r}^{″} ⅆ {r}^{″} ⅆ {z}^{″} \qquad ( 28 )$$

EQ. (27) can be rewritten as:

$$\begin{matrix}ξ = \frac{1}{2 π} {\int }_{{r}^{″} = 0}^{{r}^{″} = ∞} {\int }_{{z}^{″} = - ∞}^{{z}^{″} = ∞} {\int }_{η = 0}^{η = ∞} {\int }_{γ = - ∞}^{γ = ∞} {ξ}_{0} ( r , {r}^{″} , z , {z}^{″} ) \times & ( 29 ) \\ \times {ⅇ}^{- [ α ( t - τ ) ( {η}^{2} + {γ}^{2} ) + i ( {z}^{″} - {z}^{′} ) γ ]} {J}_{0} ( {r}^{″} η ) {J}_{0} ( {r}^{′} η ) η ⅆ η ⅆ γ {r}^{″} ⅆ {r}^{″} ⅆ {z}^{″} & \end{matrix}$$

Additionally, performing the integration over γ, and using EQ. (9), we obtain:

$$ξ = \frac{1}{2 π} \sqrt{\frac{π}{α ( t - τ )}} {\int }_{{r}^{″} = 0}^{{r}^{″} = ∞} {\int }_{{z}^{″} = - ∞}^{{z}^{″} = ∞} {\int }_{η = 0}^{η = ∞} {ξ}_{0} ( r , {r}^{″} , z , {z}^{″} ) {ⅇ}^{- {( {z}^{″} - {z}^{′} )}^{2} / 4 α ( t - τ )} \times \\ \times {ⅇ}^{- α ( t - τ ) {η}^{2}} {J}_{0} ( {r}^{″} η ) {J}_{0} ( {r}^{′} η ) η ⅆ η {r}^{″} ⅆ {r}^{″} ⅆ {z}^{″} \qquad ( 30 )$$

Next, to perform the integration over η, the following relationship is used:

$${\int }_{0}^{∞} {ⅇ}^{- a x} {J}_{n} ( 2 b \sqrt{x} ) {J}_{n} ( 2 c \sqrt{x} ) ⅆ x = \frac{1}{a} {I}_{n} ( ( 2 b c ) / a ) {ⅇ}^{- [ {b}^{2} + {c}^{2} ] / a} \qquad ( 31 )$$

where Iₙ( ) is a Modified Bessel Function of the First Kind of order n. Thus, EQ. (30) can be rewritten as:

$$ξ = \sqrt{\frac{1}{16 {π [ α ( t - τ ) ]}^{3}}} {\int }_{{r}^{″} = 0}^{{r}^{″} = ∞} {\int }_{{z}^{″} = - ∞}^{{z}^{″} = ∞} {ξ}_{0} ( r , {r}^{″} , z , {z}^{″} ) {ⅇ}^{- [ {r}^{{′}^{2}} + {r}^{{″}^{2}} + {( {z}^{″} - {z}^{′} )}^{2} ] / 4 α ( t - τ )} {I}_{0} ( \frac{{r}^{′} {r}^{″}}{2 α ( t - τ )} ) {r}^{″} ⅆ {r}^{″} ⅆ {z}^{″} \qquad ( 32 )$$

Given that the problem involves only in the half-infinite space defined by z=0 to z=∞, EQ. (32) is rewritten as:

$$\begin{matrix}ξ = \sqrt{\frac{1}{16 {π [ α ( t - τ ) ]}^{3}}} {\int }_{{r}^{″} = 0}^{{r}^{″} = ∞} {\int }_{{z}^{″} = 0}^{{z}^{″} = ∞} {ξ}_{0} ( r , {r}^{″} , z , {z}^{″} ) {ⅇ}^{- [ {r}^{{′}^{2}} + {r}^{{″}^{2}} + {( {z}^{″} - {z}^{′} )}^{2} ] / 4 α ( t - τ )} {I}_{0} ( \frac{{r}^{′} {r}^{″}}{2 α ( t - τ )} ) {r}^{″} ⅆ {r}^{″} ⅆ {z}^{″} + \\ \\ + \sqrt{\frac{1}{16 {π [ α ( t - τ ) ]}^{3}}} {\int }_{{r}^{″} = 0}^{{r}^{″} = ∞} {\int }_{{z}^{″} = 0}^{{z}^{″} = ∞} {ξ}_{0} ( r , {r}^{″} , z , {z}^{″} ) {ⅇ}^{- [ {r}^{{′}^{2}} + {r}^{{″}^{2}} + {( {z}^{″} - {z}^{′} )}^{2} ] / 4 α ( t - τ )} {I}_{0} ( \frac{{r}^{′} {r}^{″}}{2 α ( t - τ )} ) {r}^{″} ⅆ {r}^{″} ⅆ {z}^{″} \\ & ( 33 ) \\ \text{or:} & \\ ξ = \sqrt{\frac{1}{16 {π [ α ( t - τ ) ]}^{3}}} {\int }_{{r}^{″} = 0}^{{r}^{″} = ∞} {\int }_{{z}^{″} = 0}^{{z}^{″} = ∞} {ξ}_{0} ( r , {r}^{″} , z , {z}^{″} ) {ⅇ}^{- [ {r}^{{′}^{2}} + {r}^{{″}^{2}} + {( {z}^{″} - {z}^{′} )}^{2} ] / 4 α ( t - τ )} {I}_{0} ( \frac{{r}^{′} {r}^{″}}{2 α ( t - τ )} ) {r}^{″} ⅆ {r}^{″} ⅆ {z}^{″} + \\ \\ + \sqrt{\frac{1}{16 {π [ α ( t - τ ) ]}^{3}}} {\int }_{{r}^{″} = 0}^{{r}^{″} = ∞} {\int }_{{z}^{″} = 0}^{{z}^{″} = ∞} {ξ}_{0} ( r , {r}^{″} , z , {z}^{″} ) {ⅇ}^{- [ {r}^{{′}^{2}} + {r}^{{″}^{2}} + {( {z}^{″} - {z}^{′} )}^{2} ] / 4 α ( t - τ )} {I}_{0} ( \frac{{r}^{′} {r}^{″}}{2 α ( t - τ )} ) {r}^{″} ⅆ {r}^{″} ⅆ {z}^{″} & ( 34 )\end{matrix}$$

Therefore, the Green's function solution of the homogenous diffusion EQ. (7) that satisfies the boundary conditions of EQS. (2) and (3), reflects the cylindrical symmetry of the problem, and is defined for the half-infinite space z=0 to z=∞ is given by the following equation:

$$G ( r , {r}^{′} , z , {z}^{′} , t - τ ) = \frac{{ⅇ}^{- [ {r}^{2} + {r}^{′2} ] / 4 α ( t - τ )}}{\sqrt{16 {π [ α ( t - τ ) ]}^{3}}} ( {ⅇ}^{- {[ z - {z}^{′} )}^{2} / 4 α ( t - τ )} + {ⅇ}^{- {[ z + {z}^{′} )}^{2} / 4 α ( t - τ )} ) {I}_{0} ( \frac{r {r}^{′}}{2 α ( t - τ )} ) . \qquad ( 35 )$$

Therefore, in light of the Green's function solution of EQ. (35), the solution of inhomogeneous EQ. (6) incorporating the boundary condition of EQ. (2) is straightforward as shown below:

$$T = {\int }_{{r}^{′} = 0}^{{r}^{′} = ∞} {\int }_{{z}^{′} = 0}^{{z}^{′} = ∞} {\int }_{τ = 0}^{τ = t} G ( r , {r}^{′} , z , {z}^{′} , t - τ ) ( κ {e}^{- k {z}^{′}} + δ ( τ ) {T}_{0} ) {r}^{′} ⅆ {r}^{′} ⅆ {z}^{′} ⅆ τ \qquad ( 36 )$$

For consistency, we first evaluate the boundary condition term above corresponding to t=0 and assuming T₀ is a constant. The integration over τ has been considered trivial.

Using the following definite integral:

$${\int }_{0}^{∞} {ⅇ}^{- ( {ax}^{2} + bx + c )} ⅆ x = \frac{1}{2} \sqrt{\frac{π}{a}} {ⅇ}^{( {b}^{2} - 4 a c ) / 4 a} erfc ( \frac{b}{2 \sqrt{a}} ) \qquad ( 37 )$$

where “erfc” is the complementary error function, defined by:

$$erfc ( p ) = \frac{2}{\sqrt{π}} {\int }_{p}^{∞} {ⅇ}^{- {x}^{2}} ⅆ x \qquad ( 38 )$$

as well as the identities:

erfc(p)=1−erf(p) (39)

where “erf” is the error function, defined by:

$$erf ( p ) = \frac{2}{\sqrt{π}} {\int }_{0}^{p} {ⅇ}^{- {x}^{2}} ⅆ x \qquad ( 40 )$$

and

erf(−p)=−erf(p) (41)

the integration over z′, in the second term in EQ. (36) becomes:

$${\int }_{{r}^{′} = 0}^{{r}^{′} = ∞} {\int }_{{z}^{′} = 0}^{{z}^{′} = ∞} {\int }_{τ = 0}^{τ = i} G ( r , {r}^{′} , z , {z}^{′} , t - τ ) δ ( τ ) {T}_{0} {r}^{′} ⅆ {r}^{′} ⅆ {z}^{′} ⅆ τ = \frac{{ⅇ}^{- {r}^{2} / 4 α t}}{2 α t} {T}_{0} {\int }_{{r}^{′} = 0}^{{r}^{′} = ∞} {ⅇ}^{- {r}^{2} / 4 α t} {I}_{0} ( \frac{{rr}^{′}}{2 α t} ) {r}^{′} ⅆ {r}^{′} \qquad ( 42 )$$

Next, we can make use of the identity:

I₀(x)=J₀(ix)

and the definite integral of EQ. (10) to obtain:

$${\int }_{{r}^{′} = 0}^{{r}^{′} = ∞} {\int }_{{z}^{′} = 0}^{{z}^{′} = ∞} {\int }_{τ = 0}^{τ = i} G ( r , {r}^{′} , z , {z}^{′} , t - τ ) δ ( τ ) {T}_{0} {r}^{′} ⅆ {r}^{′} ⅆ {z}^{′} ⅆ τ = {T}_{0} \qquad ( 43 )$$

Note that this result is entirely consistent with the boundary condition of EQ. (2), since the first term on the right in EQ. (36):

$${\int }_{{r}^{′} = 0}^{{r}^{′} = ∞} {\int }_{{z}^{′} = 0}^{{z}^{′} = ∞} {\int }_{τ = 0}^{τ = i} G ( r , {r}^{′} , z , {z}^{′} , t - τ ) κ {e}^{- k {z}^{′}} {r}^{′} ⅆ {r}^{′} ⅆ {z}^{′} ⅆ τ \qquad ( 44 )$$

vanishes for t=0. Furthermore, the results of EQ. (43) indicate that our Green's function solution is properly normalized. Thus, EQ. (36) becomes:

$$T = {T}_{0} + \begin{matrix}{\int }_{{r}^{′} = 0}^{{r}^{′} = ∞} {\int }_{{z}^{′} = 0}^{{z}^{′} = ∞} {\int }_{τ = 0}^{τ = i} G ( r , {r}^{′} , z , {z}^{′} , t - τ ) κ {e}^{- k {z}^{′}} {r}^{′} ⅆ {r}^{′} ⅆ {z}^{′} ⅆ τ & \end{matrix} \qquad ( 45 )$$

where the Green's function is given in EQ. (35). EQ. (45) may be rewritten as:

$$T = {T}_{0} + {\int }_{{r}^{′} = 0}^{{r}^{′} = ∞} {\int }_{τ = 0}^{τ = i} \frac{{ⅇ}^{- [ {r}^{2} + {r}^{′2} + {z}^{2} ] / 4 α ( t - τ )}}{\sqrt{16 {π [ α ( t - τ ) ]}^{3}}} Γ ( z ) {I}_{0} ( \frac{r {r}^{′}}{2 α ( t - τ )} ) κ {r}^{′} ⅆ {r}^{′} ⅆ τ \qquad ( 46 )$$

where the integral over z′ has been collected into the term I(z):

$$Γ ( z ) = {\int }_{{z}^{′} = 0}^{{z}^{′} = ∞} ( {ⅇ}^{- [ ( {z}^{{′}^{2}} - 2 {z}^{′} z ) / 4 α ( t - τ ) ] - k {z}^{′}} + {ⅇ}^{- [ ( {z}^{{′}^{2}} - 2 {z}^{′} z ) / 4 α ( t - τ ) ] - k {z}^{′}} ) ⅆ {z}^{′} \qquad ( 47 )$$

Of particular interest is the solution to the diffusion equation at the planar weldable surface defined by z=0. Using the definite integral of EQ. (37), the solution to EQ. (47) at z=0 is the following:

I(z=0)=\sqrt{4πα(t−τ)}e^{k}^{²}^{α(t-τ)}erfc[k\sqrt{α(t−τ)}] (48)

When EQ. (46) is evaluated at z=0, therefore, EQ. (46) is rewritten as the following:

$$T {\vert}_{z = 0} - {T}_{0} = \frac{1}{2} {\int }_{{r}^{′} = 0}^{{r}^{′} = ∞} {\int }_{τ = 0}^{τ = i} {ⅇ}^{{k}^{2} α ( t - τ )} κ erfc [ k \sqrt{α ( t - τ )} ] \frac{{ⅇ}^{- [ {r}^{2} + {r}^{′2} ] / 4 α ( t - τ )}}{[ α ( t - τ ) ]} {I}_{0} ( \frac{r {r}^{′}}{2 α ( t - τ )} ) {r}^{′} ⅆ {r}^{′} ⅆ τ \qquad ( 49 )$$

It follows that the solution of EQ. (49) for z=0 and r=0.

$$\begin{matrix}T {\vert}_{\begin{matrix}r = 0 \\ z = 0\end{matrix}} = {T}_{0} + \frac{1}{2} {\int }_{{r}^{′} = 0}^{{r}^{′} = ∞} {\int }_{τ = 0}^{τ = i} {ⅇ}^{{k}^{2} α ( t - τ )} κ erfc [ k \sqrt{α ( t - τ )} ] \frac{{ⅇ}^{- {r}^{′2} / 4 α ( t - τ )}}{[ α ( t - τ ) ]} {r}^{′} ⅆ {r}^{′} ⅆ τ & \end{matrix} \qquad ( 50 )$$

To proceed, it is necessary to introduce the r′ dependence of the κ term. The variable κ was introduced in EQ. (5) as:

$$κ = \frac{kI}{cρ} \qquad ( 51 )$$

For a TEM 00 mode laser where the Intensity distribution I as a function of r′ is Gaussian with width α, those skilled in the art will appreciate that variable κ may be written as:

κ=κ₀e^{-2 r′}^{²}^{/α}^{²} (52)

where κ₀ is not a function of r′. Thus, EQ. (50) may be rewritten:

$$\begin{matrix}T {\vert}_{\begin{matrix}r = 0 \\ z = 0\end{matrix}} = {T}_{0} + \frac{{κ}_{0}}{2} {\int }_{{r}^{′} = 0}^{{r}^{′} = ∞} {\int }_{τ = 0}^{τ = i} {ⅇ}^{{k}^{2} α ( t - τ )} erfc [ k \sqrt{α ( t - τ )} ] \frac{{ⅇ}^{- {r}^{′2} [ 1 / 4 α ( t - τ ) + 2 / {a}^{2} ]}}{[ α ( t - τ ) ]} {r}^{′} ⅆ {r}^{′} ⅆ τ & \end{matrix} \qquad ( 53 )$$

The integration over r′ in EQ. (53) is trivial, and yields:

$$T {\vert}_{\begin{matrix}r = 0 \\ z = 0\end{matrix}} = {T}_{0} + {κ}_{0} {\int }_{τ = 0}^{τ = i} {ⅇ}^{{k}^{2} α ( t - τ )} \frac{erfc [ k \sqrt{α ( t - τ )} ]}{[ 1 + 8 α ( t - τ ) / {a}^{2} ]} ⅆ τ \qquad ( 54 )$$

Making a substitution of variables as follows:

$$a ( t - τ ) = {a}^{2} \frac{θ}{2} \qquad ( 55 )$$

implies that

$$ⅆ τ = - \frac{{a}^{2}}{2 α} ⅆ θ \qquad ( 56 )$$

and EQ. (54) becomes the general thermal balancing relationship advantageously embodied within fusion welding program 160 as part of quartz welding system 1 illustrated in FIG. 1:

$$T {\vert}_{\begin{matrix}r = 0 \\ z = 0\end{matrix}} = {T}_{0} + \frac{{a}^{2} {κ}_{0}}{2 α} {\int }_{θ = 0}^{θ = \frac{2 α t}{{a}^{2}}} {ⅇ}^{{k}^{2} {α}^{2} \frac{θ}{2} \frac{erfc ( ka \sqrt{\frac{θ}{2}} )}{[ 1 + 4 θ ]}} ⅆ θ \qquad ( 57 )$$

In an example involving a quartz plate as the quartz workpiece, the quartz plate is to be heated by a TEM 01* mode CO₂ laser beam (where the TEM 01* mode is the conventionally referred to as the “doughnut mode”). The workpiece parameters and heat source parameters are entered into the computer. In one embodiment of the present invention, fusion welding program 160 generates a prompt message on monitor 105 requesting that the user input the various workpiece parameters and heat source parameters. In response, the user enters the information into the computer manually through input device 110 or by causing program data files 165 to become available to fusion welding program 160. In another embodiment, the workpiece parameters and heat source parameters are already in program data files 165 accessible to the processor 120 and are identified, accessed and received by fusion welding program 160.

In the example, the heat source is laser energy source 170 providing laser beam 185 having a hollow ring geometry with a width h and an average diameters β. Thus, the inner diameter of the heat source ring will be effectively β−h/2, and the outer diameter will be effectively β+h/2. In this instance, in the plane z=0, EQ. (50) has the form, at r=β+h/2:

$$T {\vert}_{\begin{matrix}r = β + h / 2 \\ z = 0\end{matrix}} = {\int }_{{r}^{′} = β - h / 2}^{{r}^{′} = β + h / 2} {\int }_{τ = 0}^{τ = i} {ⅇ}^{{k}^{2} α ( t - τ )} κ erfc [ k \sqrt{α ( t - τ )} ] \frac{{ⅇ}^{- ( {[ β + h / 2 )}^{2} + {r}^{′2} ] / 4 α ( t - τ )}}{2 [ α ( t - τ ) ]} {I}_{0} ( \frac{( β + h / 2 ) {r}^{′}}{2 α ( t - τ )} ) {r}^{′} ⅆ {r}^{′} ⅆ τ + {T}_{0} \qquad ( 58 )$$

EQ. (5 8) may be approximated by assuming that the width h of the heat source is small enough such that the terms inside the integrand of EQ. (58) vary only slightly as a function of r′ as r′ takes on the values between β−h/2 and β+h/2. Thus, r′≈β within the integral, and the integral over dr′ becomes ∫dr′=h, and κ≈κ₀. Therefore

$$T {\vert}_{\begin{matrix}r = β + h / 2 \\ z = 0\end{matrix}} = {T}_{0} + \frac{{κ}_{0} β h}{2 } {\int }_{τ = 0}^{τ = i} {ⅇ}^{{k}^{2} α ( t - τ )} erfc [ k \sqrt{α ( t - τ )} ] \frac{{ⅇ}^{- ( {[ β + h / 2 )}^{2} + {β}^{2} ] / 4 α ( t - τ )}}{[ α ( t - τ ) ]} {I}_{0} ( \frac{( β + h / 2 ) β}{2 α ( t - τ )} ) ⅆ τ \qquad ( 59 )$$

Similar to the substitution used above, we make the substitution of variables

$$α ( t - τ ) = {β}^{2} \frac{θ}{4} \qquad ( 60 )$$

which implies that

$$d τ = - \frac{{β}^{2}}{4 α} d θ \qquad ( 61 )$$

and EQ. (59) takes on the form:

$$T {\vert}_{\begin{matrix}r = β + h / 2 \\ z = 0\end{matrix}} = {T}_{0} + \frac{{κ}_{0} β h}{2 α} {\int }_{θ = 0}^{θ = \frac{4 α t}{{β}^{2}}} {ⅇ}^{{k}^{2} {β}^{2} \frac{θ}{4}} erfc ( κ β \sqrt{\frac{θ}{4}} ) {ⅇ}^{- {h}^{2} / ( 4 θ {β}^{2} )} \frac{{ⅇ}^{- \frac{2}{θ} ( 1 + h {/}_{( 2 β )} )}}{θ} {I}_{0} ( \frac{2}{θ} ( 1 + h {/}_{( 2 β )} ) ) ⅆ θ \qquad ( 62 )$$

When applying energy to the quartz workpiece, such as a quartz plate, there is a certain amount of heat loss. This can be accounted for and the determined amount of energy needed to bring the quartz workpiece is then advantageously adjusted to compensate for losing a portion of the energy applied by the heat source (e.g., laser energy source 170). In the exemplary embodiment, radiant heat loss from applying the laser beam to the weldable surface of the quartz workpiece (such as the sample quartz plate) can be estimated and adjusted for by using a radiant emmicivity at an estimated or empirically determined percentage of its original value. Embodiments of the present invention also contemplate other methods of estimating or calculating heat loss.

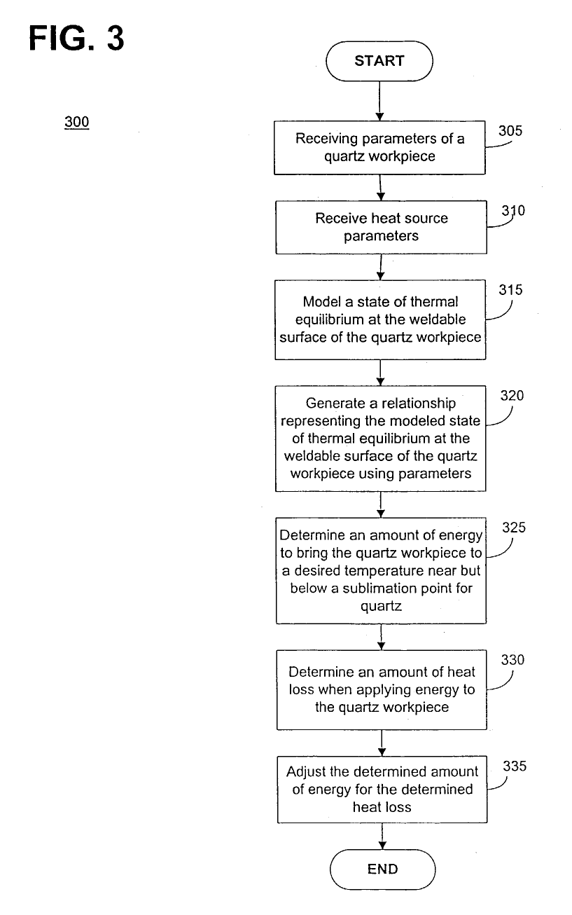

In the context of the above description and information, further details on steps of an exemplary method consistent with the present invention for determining the amount of energy required to bring a quartz workpiece to a fusion weldable condition will now be explained with reference to the flowchart of FIG. 3. Referring now to FIGS. 1-3, the method 300 begins at step 305 when parameters of a quartz workpiece are received. Typically, these include dimensional data describing the physical dimensions of the quartz workpiece and thermal properties of the quartz workpiece. Likewise, at step 310, heat source parameters are received. The heat source parameters describe the energy to be applied to the workpiece and normally include quantifiable energy characteristics such as beam energy attributes and beam geometry attributes. At this point, fusion welding program 160 is able to access these parameters related to the welding process.

At step 315, a state of thermal equilibrium is modeled at the weldable surface of the quartz workpiece. Given that quartz has been found to exhibit a thinning heated boundary layer as it is heated, the state of thermal equilibrium is focused on that weldable surface as described above.

At step 320, a thermal balancing relationship is generated which represents the modeled state of thermal equilibrium. This is typically accomplished using a differential equation, such as a diffusion equation, with boundary conditions and applying a Green's function to find a solution to the equation. At step 325, the relationship is used to yield an amount of energy needed to bring the quartz workpiece to a desired temperature near but below a sublimation point, based upon the provided parameters. Normally, this information is then advantageously used to setup and control the application of energy to the quartz workpiece.

In order to account for heat loss during the anticipated application of energy, the system further determines an amount of heat loss that should occur when energy is applied to the quartz workpiece in step 330. In the exemplary embodiment, the heat loss is estimated using a radiated emmicivity at ninety percent the value for a absolute black body. However, other embodiments of the present invention may estimate heat loss using other methods or theoretically calculate the amount of anticipated heat loss as part of the determination. Finally, at step 335, the amount of energy that should be applied to the workpiece is adjusted for the heat loss so that the appropriate amount of energy is applied to bring the workpiece to the optimal fusion weldable condition.

Those skilled in the art will appreciate that embodiments consistent with the present invention may be implemented in a variety of technologies, such as programs written in any type of computer programming language including assembly language, Microsoft Visual Basic, Java, and Microsoft C++.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone. The invention may be implemented with both object-oriented and non-object-oriented programming systems. While the above description encompasses one embodiment of the present invention, the scope of the invention is defined by the claims and their equivalents.

What is claimed is:

1. A method for determining an amount of energy required to bring a quartz workpiece to a fusion weldable condition, comprising the steps of:
identifying parameters of the quartz workpiece related to a weldable surface of the quartz workpiece;
identifying heat source parameters associated with energy to be applied to the weldable surface of the quartz workpiece; and
determining the amount of energy required to bring the quartz workpiece to the fusion weldable condition based upon the parameters of the quartz workpiece and the heat source parameters, the fusion weldable condition being a state at which the quartz workpiece is at a thermal balance point and becomes optimally weldable.

2. The method of claim 1, wherein the fusion weldable condition is substantially near but below a sublimation point of the quartz workpiece and where the quartz workpiece becomes reflective.

3. The method of claim 1, wherein the determining step further comprises:
modeling a state of thermal equilibrium for the quartz workpiece at the weldable surface; and
determining the amount of energy required to heat the quartz workpiece to the desired thermal balance condition using the parameters of the quartz workpiece and the heat source parameters as part of the modeled state of thermal equilibrium.

4. The method of claim 3, wherein the modeling step further comprises:
generating a relationship representing the modeled state of thermal equilibrium, the relationship associating a desired temperature of the quartz workpiece and a transit time for a heat source applying energy to the quartz workpiece; and
determining the amount of energy according to the generated relationship and using a predetermined value for the desired temperature of the quartz workpiece, the predetermined value being near but below a sublimation temperature for the quartz workpiece.

5. The method of claim 4, wherein the generating step further comprises resolving a differential equation with a plurality of boundary conditions in order to generate the relationship representing the state of thermal equilibrium.

6. The method of claim 5, wherein the generating step further comprises applying an integrating kernel to resolve the differential equation with the boundary conditions and generate the relationship representing the state of equilibrium.

7. The method of claim 6, wherein the generating step further comprises applying a Green's function as the integrating kernel.

8. The method of claim 1 further comprising the step of accounting for heat loss when determining the amount of energy required to bring the quartz workpiece to the desired thermal balance condition.

9. The method of claim 8, wherein the accounting step further comprises adjusting the determined amount of energy to compensate for losing a portion of the energy to be applied to the weldable surface of the workpiece.

10. The method of claim 1, wherein the parameters of the quartz workpiece include a plurality of thermal properties of the quartz workpiece and dimensional data associated with the weldable surface of the quartz workpiece.

11. The method of claim 1, wherein the heat source parameters are quantifiable characteristics describing how energy from a heat source is to be applied to the weldable surface of the quartz workpiece.

12. The method of claim 11, wherein the quantifiable characteristics are laser parameters associated with a laser energy source having a predefined wavelength.

13. The method of claim 12, wherein the laser parameters include a plurality of beam energy attributes and a plurality of beam geometry attributes.

14. The method of claim 13, wherein the beam energy attributes represent a power level in a beam coming from the laser energy source, a duration of the beam, and a distribution of energy within the beam.

15. The method of claim 13, wherein the beam geometry attributes represent one or more focal characteristics of a beam from the laser energy source and one or more spot dimensions of the beam.

16. A system for determining an amount of energy required to bring a quartz workpiece to a fusion weldable condition, comprising:
a processor;
a memory storage device coupled to the processor for maintaining parameters of the quartz workpiece related to a weldable surface of the quartz workpiece, the memory storage device further maintaining heat source parameters associated with energy to be applied to the weldable surface of a quartz work piece;
an input device coupled to the processor, the input device being operative to receive the parameters of the quartz workpiece and the heat source parameters; and
the processor being operative to
identify the parameters of the quartz workpiece,
identify the heat source parameters, and
determine the amount of energy required to bring the quartz workpiece to the fusion weldable condition based upon the parameters of the quartz workpiece and the heat source parameters, the fusion weldable condition being a state at which the quartz workpiece is at a thermal balance point substantially near but below a sublimation point of the quartz workpiece and becomes optimally weldable.

17. The system of claim 16, wherein the processor is further operative to generate a prompt message related to the parameters of the quartz workpiece and the heat source parameters; and
wherein the input device is operative to receive the parameters of the quartz workpiece and the heat source parameters in response to the prompt.

18. The system of claim 16, wherein the processor is further operative to:
model a state of thermal equilibrium for the quartz workpiece at the weldable surface; and
determine the amount of energy required to heat the quartz workpiece to the desired thermal balance condition using the parameters of the quartz workpiece and the heat source parameters as part of the modeled state of thermal equilibrium.

19. The system of claim 18, wherein the processor is further operative to:
generate a relationship representing the modeled state of thermal equilibrium, the relationship associating a desired temperature of the quartz workpiece and a transit time for a heat source applying energy to the quartz workpiece; and
determine the amount of energy according to the generated relationship and using a predetermined value for the desired temperature of the quartz workpiece, the predetermined value being near but below a sublimation temperature for the quartz workpiece.

20. The system of claim 19, wherein the processor is further operative to resolve a differential equation with a plurality of boundary conditions in order to generate the relationship representing the state of thermal equilibrium.

21. The system of claim 20, wherein the processor is further operative to apply an integrating kernel to resolve the differential equation with the boundary conditions and generate the relationship representing the state of equilibrium.

22. The system of claim 21, wherein the processor is further operative to apply a Green's function as the integrating kernel to generate the relationship representing the state of equilibrium.

23. The system of claim 16, wherein the processor is further operative to adjust the determined amount of energy to compensate for losing a portion of the energy to be applied to the weldable surface of the workpiece.

24. The system of claim 16, wherein the parameters of the quartz workpiece include a plurality of thermal properties of the quartz workpiece and dimensional data associated with the weldable surface of the quartz workpiece.

25. The system of claim 16, wherein the heat source parameters are quantifiable characteristics describing how energy from a heat source is to be applied to the weldable surface of the quartz workpiece.

26. The system of claim 25, wherein the quantifiable characteristics are laser parameters associated with a laser energy source having a predefined wavelength.

27. The system of claim 26, wherein the laser parameters include a plurality of beam energy attributes and a plurality of beam geometry attributes.

28. The system of claim 27, wherein the beam energy attributes represent a power level in a beam coming from the laser energy source, a duration of the beam, and a distribution of energy within the beam.

29. The system of claim 27, wherein the beam geometry attributes represent one or more focal characteristics of a beam from the laser energy source and one or more spot dimensions of the beam.

30. A computer-readable medium containing instructions for determining an amount of energy required to bring a quartz workpiece to a fusion weldable condition, which when the instructions are executed, comprise the steps of:
identifying parameters of the quartz workpiece related to a weldable surface of the quartz workpiece;
identifying heat source parameters associated with energy to be applied to the weldable surface of the quartz workpiece; and
determining the amount of energy required to bring the quartz workpiece to the fusion weldable condition based upon the parameters of the quartz workpiece and the heat source parameters, the fusion weldable condition being a state at which the quartz workpiece is at a thermal balance point and becomes optimally weldable.

31. The computer-readable medium of claim 30, wherein the fusion weldable condition is substantially near but below a sublimation point of the quartz workpiece and where the quartz workpiece becomes reflective.

32. The computer-readable medium of claim 30, wherein the determining step further comprises:
modeling a state of thermal equilibrium for the quartz workpiece at the weldable surface; and
determining the amount of energy required to heat the quartz workpiece to the desired thermal balance condition using the parameters of the quartz workpiece and the heat source parameters as part of the modeled state of thermal equilibrium.

33. The computer-readable medium of claim 32, wherein the modeling step further comprises:
generating a relationship representing the modeled state of thermal equilibrium, the relationship associating a desired temperature of the quartz workpiece and a transit time for a heat source applying energy to the quartz workpiece; and
determining the amount of energy according to the generated relationship and using a predetermined value for the desired temperature of the quartz workpiece, the predetermined value being near but below a sublimation temperature for the quartz workpiece.

34. The computer-readable medium of claim 33, wherein the generating step further comprises resolving a differential equation with a plurality of boundary conditions in order to generate the relationship representing the state of thermal equilibrium.

35. The computer-readable medium of claim 34, wherein the generating step further comprises applying an integrating kernel to resolve the differential equation with the boundary conditions and generate the relationship representing the state of equilibrium.

36. The computer-readable medium of claim 35, wherein the generating step further comprises applying a Green's function as the integrating kernel.

37. The computer-readable medium of claim 30 further comprising the step of accounting for heat loss when determining the amount of energy required to bring the quartz workpiece to the desired thermal balance condition.

38. The computer-readable medium of claim 37, wherein the accounting step further comprises adjusting the determined amount of energy to compensate for losing a portion of the energy to be applied to the weldable surface of the workpiece.

39. The computer-readable medium of claim 30, wherein the parameters of the quartz workpiece include a plurality of thermal properties of the quartz workpiece and dimensional data associated with the weldable surface of the quartz workpiece.

40. The computer-readable medium of claim 39, wherein the heat source parameters are quantifiable characteristics describing how energy from a heat source is to be applied to the weldable surface of the quartz workpiece.

41. The computer-readable medium of claim 40, wherein the quantifiable characteristics are laser parameters associated with a laser energy source having a predefined wavelength.

42. The computer-readable medium of claim 41, wherein the laser parameters include a plurality of beam energy attributes and a plurality of beam geometry attributes.

43. The computer-readable medium of claim 42, wherein the beam energy attributes represent a power level in a beam coming from the laser energy source, a duration of the beam, and a distribution of energy within the beam.

44. The computer-readable medium of claim 42, wherein the beam geometry attributes represent one or more focal characteristics of a beam from the laser energy source and one or more spot dimensions of the beam.
